(19) United States
(12) Patent Application Publication
(10) Pub. No.: US 2004/0148241 A1
(43) Pub. Date: Jul. 29, 2004

(54) Method of evaluating a portfolio of leased items

(76) Inventors: Thomas J. Qi, Mineola, NY (US); Yan Peng, Mineola, NY (US); Kirtikumar Ishverlal Mandalaywala, Albertson, NY (US)

Correspondence Address: GLEN E. BOOKS, ESQ., LOWENSTEIN SANDLER PC, 65 Livingston Avenue, Roseland, NJ, 07068-1791, US

(21) Appl. No.: 10/601,900

(22) Filed: Jun. 23, 2003

Related U.S. Application Data
(60) Provisional application No. 60/442,491, filed on Jan. 24, 2003.

(51) Int. Cl. G06F 17/60

(52) U.S. Cl. 705/36

(57) ABSTRACT

A method is provided for evaluating a portfolio of leased depreciable items subject to uncertain occurrences affecting residual value. In essence, the method comprises identifying uncertain occurrences which affect residual value, estimating the probabilities of the occurrences and when they will happen, and estimating the value of the portfolio as a function of the probabilities of the occurrences, their distribution in time and estimates of the depreciated value. Advantageously, the estimates of portfolio value can also include adjustments for inflation and the resale experience. The method can readily be expanded to accommodate complex portfolios including plural categories of items subject to different depreciation schedules and adjustments. The risk of residual value loss can then be measured by the change in estimated value, and appropriate reserves can be provided for the risk.

### CROSS REFERENCE TO RELATED APPLICATIONS

This application claims the benefit of U.S. Provisional Applications Serial No. 60/442,491 filed Jan. 24, 2003. The 60/442,491 application is incorporated herein by reference.

### FIELD OF THE INVENTION

This invention relates to methods of evaluating a portfolio of leased items. It is useful for estimating the residual value of a portfolio of leased items subject to depreciation and uncertain occurrences which can affect residual value risk. It is particularly useful for providing an appropriate level of reserves for residual value loss risk.

### BACKGROUND OF THE INVENTION

Methods for evaluating portfolios of leased items and providing appropriate levels of reserve are important in leasing. Leasing of various items such as cars, trucks, airplanes, ships, office equipment and furniture is a large and growing business. In such business it is common that a leasing company (lessor) will have a large portfolio of leased items that depreciate with time and are subject to uncertain occurrences that modulate the residual value of the leased items. Items will have different residual value affects on the lessor depending on when they are received back and the conditions under which the lease is ended. The uncertainty in the nature and timing of the occurrences present the lessor with an uncertain portfolio value and a risk of residual value loss.

It is important that leasing companies provide appropriate but not excessive reserves to cover the risk of residual value loss. Determination and provision of appropriate reserves can smooth out the effects of loss, provide a basis for insuring residual value and provide guidance in the choice of items to lease. Excess reserves, in contrast, represent nonproductive capital.

Accordingly there is a need for a method of efficiently evaluating large portfolios of leased items and providing reserves for residual value loss risk.

### SUMMARY OF THE INVENTION

A method is provided for evaluating a portfolio of leased depreciable items subject to uncertain occurrences affecting residual value. In essence, the method comprises identifying uncertain occurrences which affect residual value, estimating the probabilities of the occurrences and when they will happen, and estimating the value of the portfolio as a function of the probabilities of the occurrences, their distribution in time and estimates of the depreciated value. Advantageously, the estimates of portfolio value can also include adjustments for inflation and the resale experience. The method can readily be expanded to accommodate complex portfolios including plural categories of items subject to different depreciation schedules and adjustments. The risk of residual value loss can then be measured by the change in estimated value, and appropriate reserves can be provided for the risk.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 is a block diagram of a method for evaluating a portfolio of leased items;

FIG. 1A is a block diagram of a system for using the inventive method;

FIG. 2 is a graph illustrating an advantageous way to allocate vehicles among occurrences;

FIG. 3 is a graph showing advantageous way of assigning dates of occurrences;

FIG. 4 is a block diagram of a software system for implementing the process of FIG. 1;

FIG. 5 is a block diagram showing the inputs and outputs of depreciation curve block 41;

FIG. 6 is a block diagram showing the functions performed by depreciation curve block 41;

FIG. 7 is a block diagram showing the inputs and outputs of used car CPI forecast block 42;

FIG. 8 is a block diagram showing the functions performed by used car CPI forecast block 42;

FIG. 9 is a block diagram showing the inputs and outputs of purchase return date forecast block 43;

FIG. 10 is a block diagram showing the functions performed by purchase return date forecast block 43;

FIG. 11 is a block diagram showing the inputs and outputs of the market value forecast block 44;

FIG. 12 is a block diagram showing the functions performed by the market value forecast block 44;

FIG. 13 is a block diagram showing the inputs and outputs of the auction adjustment block 45;

FIG. 14 is a block diagram showing the functions performed by the auction adjustment block 45;

FIG. 15 is a block diagram showing the inputs and outputs of the purchase/return market value relationship block 46;

FIG. 16 is a block diagram showing the functions performed by purchase/return market value relationship block 46;

FIG. 17 is a block diagram showing the inputs and outputs of the purchase/return early termination forecast relationship block 47;

FIG. 18 is a block diagram showing the functions performed by the purchase/return early termination forecast block 47;

FIG. 19 is a block diagram showing the inputs and outputs of the residual risk reporting block 48; and,

FIG. 20 is a block diagram showing the functions performed by the residual risk reporting block 48.

It is to be understood that the drawings are for the purpose of illustrating the concepts of the invention, and except for the graphs, are not to scale. It is also understood that all application code, other framework code, database programs, and data that can be used to implement the inventive method reside on computer readable media and run on one or more computer systems including standard computer components and operating systems as known in the art. Furthermore the invention can be implemented on a standalone computer, or the software modules necessary to implement the inventive method can be distributed among computers on an intranet or on the Internet. The inventive method can be performed by software written in programming languages as known in the art, including, but not limited to, object oriented languages such as C++, Java or J2EE.

### DETAILED DESCRIPTION

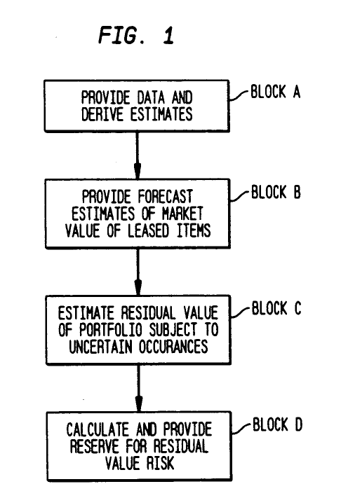

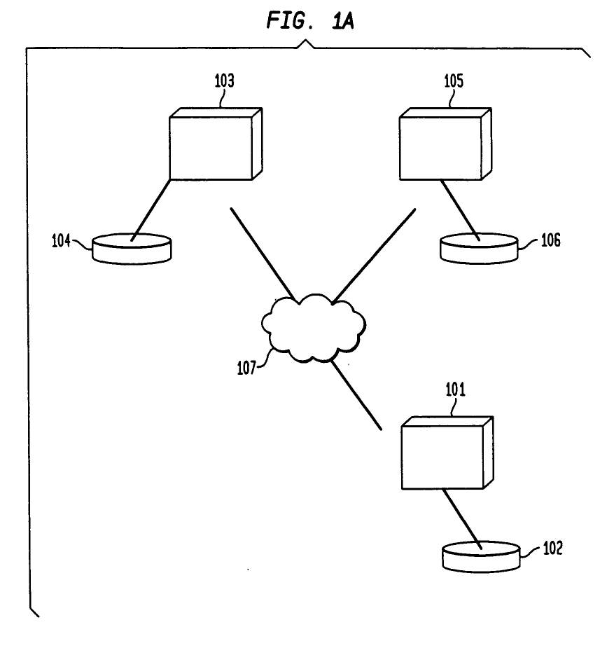

Referring to the drawings, FIG. 1 is a schematic block diagram of a method for evaluating a portfolio of leased depreciable items and providing a reserve for residual value loss risk. It is assumed that the portfolio is relatively large in relation to the initial value of the individual items so that risk is not unduly affected by a small number of events. The method can be used to evaluate portfolios of a great variety of leased depreciable items, such as cars, trucks, construction equipment, airplanes, ships, industrial and office equipment, and even furniture. It will be illustrated for use with a portfolio of leased automobiles.

As shown in Block A of FIG. 1, the first step is to provide data and derive from the data estimates, which will be used evaluating the portfolio. Typically the item being leased is subject to depreciation. It is desirable to provide a forecast estimate of depreciation as a function of time. Enhanced accuracy can be obtained by adjusting for inflation and the cost of resale. Hence it is desirable to provide a forecast estimate of inflation as a function of time and an estimate of the cost of resale. Moreover certain occurrences can affect the residual value loss risk presented to the lessor. For example, the lease may be subject to early termination, return of the item during the lease term at maturity, or rights of the leasee to purchase the item during or at maturity. These three occurrences—1) early termination, 2) return and 3) purchase—are essentially mutually exclusive and modulate the lessor's risk in different ways. Early termination by the leasee, which can occur any time during the lease, typically presents credit risk rather than value risk. Return presents depreciation and cost of sale risk dependent on the time of return, and purchase presents risk dependent on the price, time of purchase and inflation. Evaluating the portfolio and providing an appropriate reserve require an estimate of the probabilities of the types and timing of the occurrences that can have significant affects on residual value loss risk.

Applying this initial step to a portfolio of leased automobiles, data can be collected relating to depreciation, inflation in used car prices (CPI data) and the resale experience, e.g. loss or premium obtained at auction for use in estimating the residual value of leased automobiles as a function of time. It should be noted that the values of different categories of leased items will typically vary differently with time. Thus, for example, the value of a leased Nissan Altima will change differently with time than will a leased Infiniti sedan.

Using regression techniques, the data can be analyzed to model future depreciation, CPI adjustment and auction adjustment of value. The forecasting modules can then be tested by applying them to historical data and checking the fit.

The various occurrences under the leasee that affect residual value can be determined from experience. Exemplary such occurrences are: 1) early termination, 2) return and 3) purchase. Data relating to these occurrences can be then collected and subjected to regression analysis to estimate their probabilities and to model the time distribution of the respective occurrences.

The next step, shown in Block B, is to provide a forecast estimate of the market value of each vehicle in the portfolio. Using the forecast depreciation estimates and the forecast used car CPI estimates as inputs, analysis can provide forecast estimates of the market value of each vehicle. These forecast market values can advantageously be adjusted to reflect the cost of resale (auction adjustment).

The third step, Block C, is to estimate the residual value of the portfolio subject to the occurrences. The aggregated market value (sum of all vehicle value) is not the same as the expected residual value of the portfolio because the portfolio is subject to uncertain occurrences which can affect residual value. Estimation of residual value requires consideration of the probabilities of these occurrences and their distribution in time during the period pertinent to the lease.

A preferred algorithm for estimating residual value of the portfolio operates as follows.

First, the modulating occurrences are identified and estimates of their probabilities are provided. For example, in auto leasing the primary occurrences are 1) early termination, 2) return and 3) purchase. Assume for purposes of explanation, that the probabilities of these occurrences are P₁, P₂ and P₃, respectfully. (It is assumed that P₁, P₂ and P₃ are mutually exclusive and P₁+P₂+P₃=1.)

Next, for purposes of calculation, each item in the portfolio is randomly allocated to one among these occurrences in accordance with the probability distribution of the occurrences. FIG. 2 graphically illustrates an advantageous way of so allocating vehicles among early termination, return and purchase. Each vehicle is assigned a random number between 0 and 1. The vehicles are then distributed among the occurrences in accordance with the unitary mapping of the vehicle random number on a linear scale of P₁, P₂, and P₃. If, for example, vehicle 1 has a random number greater than P₁ but less than P₁+P2, vehicle 1 is allocated to the second occurrence, namely return. If vehicle 2 is assigned a random number greater than P₁+P₂, it is allocated to the third occurrence, namely purchase.

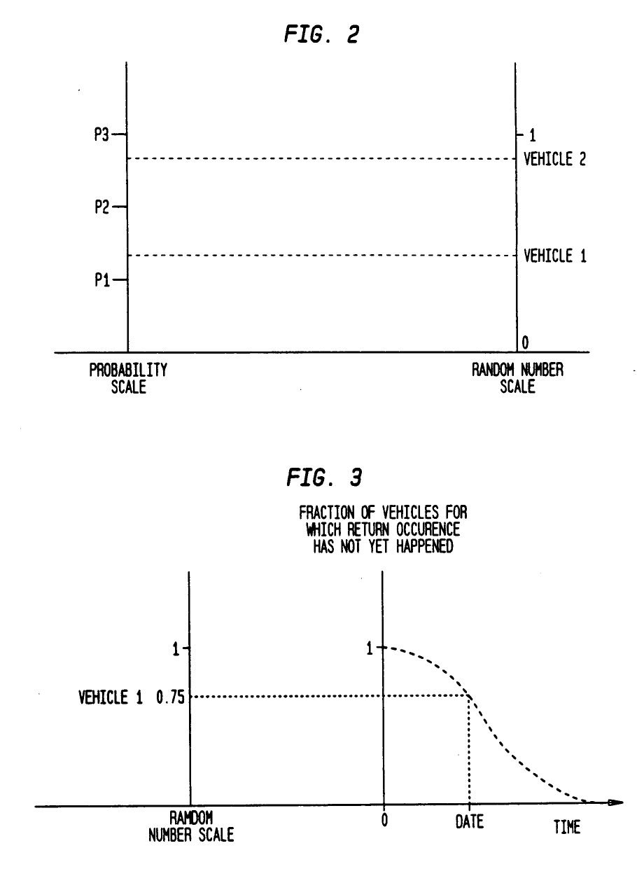

Next each item in the portfolio is assigned a date for its occurrence to happen. The dates should be assigned randomly but in accordance with the time distribution of the allocated occurrence. FIG. 3 graphically illustrates an advantageous way of assigning the dates. Each vehicle is assigned a second random number between 0 and 1. The new random number is mapped onto the occurrence time distribution curve to determine a date. If, for example, vehicle 1 (allocated to return) has a second random number 0.75, vehicle 1 is assigned the date on the distribution curve where 75% of the vehicles that will be returned will, in estimate, been returned. The adjusted market value of the vehicle at the determined date can then be calculated. This sequence of steps is carried out for each vehicle in the portfolio.

The final step shown in Block D of FIG. 1 is to calculate the residual value risk of the portfolio and to provide reserves for the risk. The calculated values for all vehicles are summed to provide an estimate of the residual value of the portfolio. Note that the individual values of the vehicles are not likely to be correct because the vehicles do not necessarily experience the occurrences and dates assigned to them. But in a large portfolio, these variations due to randomness will cancel, and the calculated sum will closely approximate the statistical expectation for the portfolio residual value. Residual value risk can then be calculated as the difference between the thus calculated residual value and a reference value (e.g. a reference value calculated under simplifying assumptions or an earlier estimated residual value).

FIG. 1A shows several computer configurations that can be suitable for evaluating a portfolio of leased items according to the inventive method. Computer 101, with its database 102 can be a standalone system. In this case all historical, market information, market projections and forecasts, depreciation data, and lease account data can reside on database 102. A computer program running on computer 101 would then accomplish the evaluation. Preferably much of the needed and useful information for carrying out the evaluation resides on one or more computers 103 configured as servers on the Internet 107 or an Intranet (not shown) associated with databases 104. Additional computer server—database pairs 105, 106, can be dedicated to specific tasks such as maintaining and supplying data related to lease accounts.

The invention may now be more clearly understood by consideration of the following specific example.

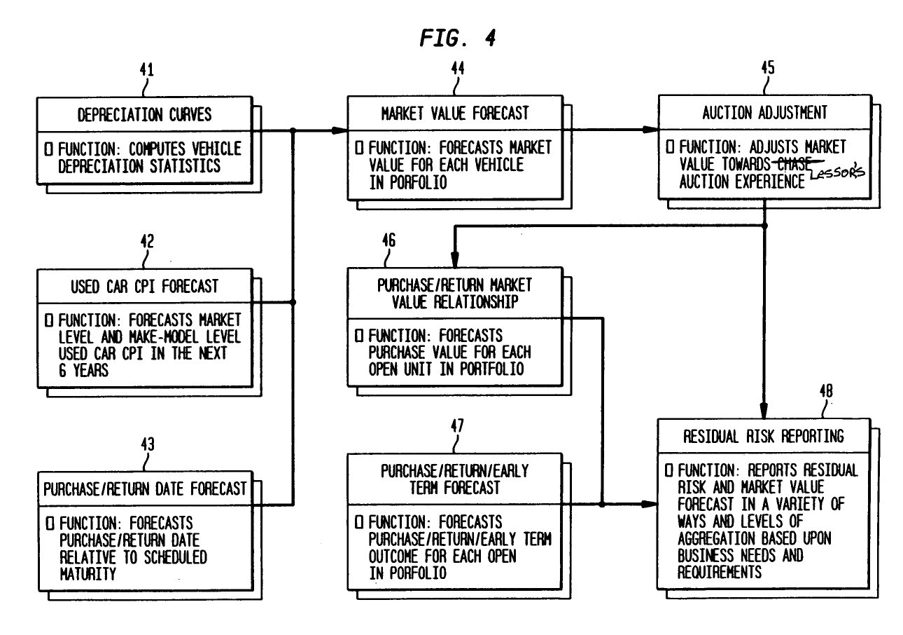

To implement the method of FIG. 1, applicants prepared a software program comprising the eight modules shown in FIG. 4. The program was to evaluate the residual value of a portfolio of automobile leases and estimate residual loss risk for the portfolio.

Modules 41, 42 and 43 provide forecast estimates to a Market Value Forecast Module 44. Specifically, Module 41 provides depreciation forecast estimates. It computes vehicle depreciation. Module 42 forecasts inflation estimates for used car values. It forecasts market level and make-model level used car CPI. Module 43 forecasts the probable dates of return or purchase relative to scheduled maturity date of the lease.

The Market Value Forecast Module 44 receives input from Modules 41, 42 and 43 and from these inputs, forecasts the market value for each vehicle in the portfolio.

The Auction Adjustment Module 45 adjusts to market value forecast by Module 44 in accordance with auction experience.

The Purchase/Return/Early Termination Module 47 forecasts the purchase/return/early termination outcomes for each open unit in the portfolio and the Purchase/Return Module 46 forecasts the purchase value for each open unit in the portfolio.

Finally the Residual Risk Reporting Module 48, receiving inputs from modules 45, 46 and 47, calculates and reports the residual risk and market value forecast. It can report these amounts in a variety of ways and levels of aggregation based on business needs.

The considerations involved in designing, testing and integrating modules to implement the method of FIG. 1 are now shown by way of a specific example of a preferred embodiment of the invention.

### EXAMPLE

In this exemplary illustration of the inventive method, the modules of FIG. 4 are discussed in more detail. The exemplary leasing portfolio evaluation pertains to an automobile leasing system. For each block number there is a corresponding block diagram showing that the inputs and outputs for that module and a block diagram expanding on the steps performed within that module. The inputs reflect input data flow to assist in understanding the block detailed descriptions. In addition to the labeled inputs, each successive block also can have access to any data that was available to a previous block.

Monte-Carlo analysis is used in several modules to generate output tables based on cumulative distribution functions and data. In 3 of the four cases (blocks 43, 46, and 47) the Monte-Carlo analysis is non-parametric. That is all of the statistical analysis is done based on discrete data points, as opposed to continuous functions. In block 45, the auction adjustment block generates estimates by a Monte-Carlo parametric model.

We begin with FIG. 4, block 41, “Depreciation Curves”. FIG. 5 shows the inputs and outputs of this function block. There are two inputs to this block, historical Black Book data, and historical used car CPI data. The output is a depreciation curve for each make and model of car. Originally block 41 generated about 40 to 50 depreciation curves, but it was discovered that more make/model specific curves yielded more accurate results. In the preferred embodiment, block 41 now generates about 10,000 depreciation curves. With more detailed make/model data, the overall system yields residual value data with higher reliability and accuracy. The format of the output is in tabular data where each table gives the vehicle value for 72 months. There is an identifier used as key field for each entry in the table. The key field comprises make, model, model year, and universal vehicle code (“UVC”) code. For each unique key field there are 73 entries, representing the projected dollar value of the vehicle for months 0 to 72.

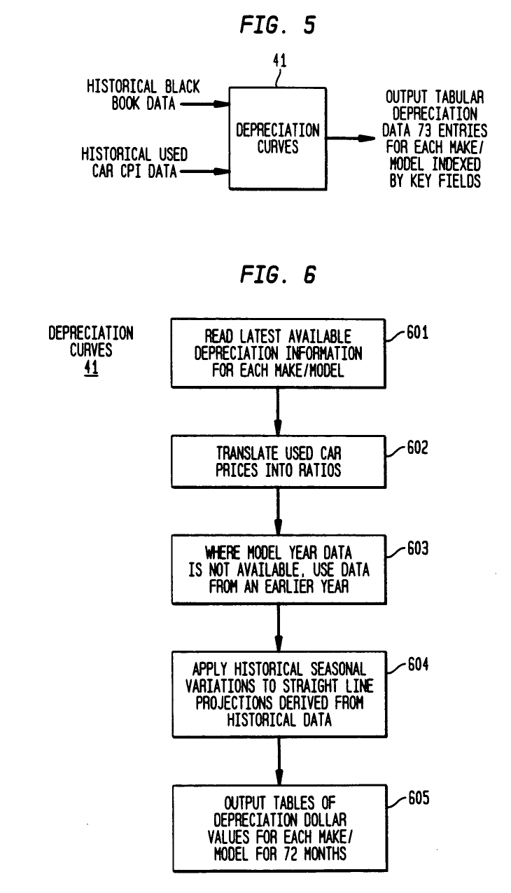

FIG. 6 shows a block diagram of the functions performed by FIG. 4, block 41. Block 41 reads latest available depreciation information for each make and model vehicle (FIG. 6, 601). It translates used car prices into ratios for each make and model for historical information (FIG. 6, 602). Then it generates projected future curves for each make and model number using year −1 as a starting value (FIG. 6, 604). Future value curves can be created (step 604) by applying seasonal trends from past historical information. Where a model year's information is not available for the needed number of years, the depreciation from a previous model year's car can be used (FIG. 6, 603). For example, if one was generating curves in 2003 for a 2000 model year, there is no actual depreciation data out as far as 60 months (5 years) since no vehicles from the 2000 model year have been in existence that long. Here historical data can be obtained from the same or similar make/model vehicle from 1998. The final step 605 in this module is the generation of the output data by applying the 5 year historical knowledge of seasonal variation to a linear regression of depreciation for a given make/model year's table.

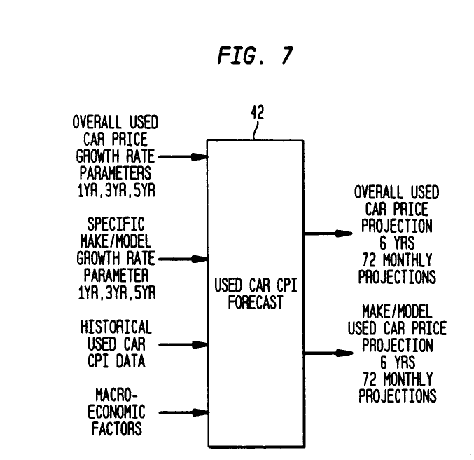

FIG. 4, block 42 is the used car consumer price index (CPI) forecast block. The inputs and outputs of block 42 are shown in FIG. 7. The inputs are the overall used car price 1 year, 3 year, and 5 year projected growth rate parameters in percentages; specific make/model 1 year, 3 year, and 5 year growth rate parameters; historical used car CPI data, and various macro economic factors including, consumer confidence, and new car vehicle sales. The outputs are the overall used car price projections over the next 6 years and the make/model used car projections. Both sets of projections are done monthly for 6 years giving 72 monthly data points in tabular form.

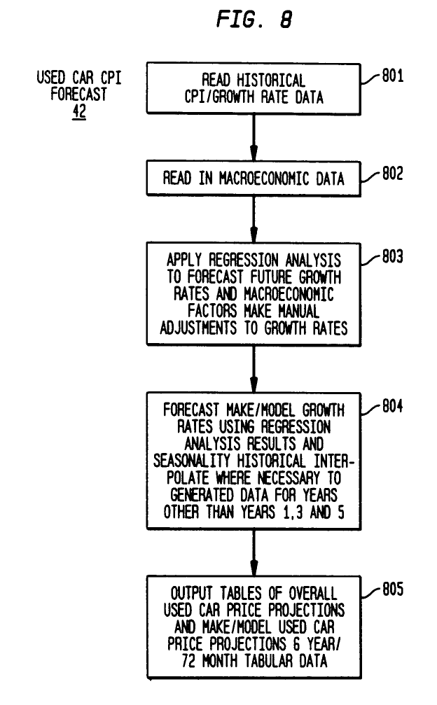

The steps representing FIG. 4, block 42, are shown in FIG. 8. First, 801, the historical CPI and growth rate data is read in. Also, 802, the macro economic data is read in. In the preferred embodiment, the macro economic data can be updated monthly. In block 803, regression analysis is used to forecast future vehicle growth rates based on historical data, macroeconomic factors. These results can then be manually adjusted. In block 804, the previous results are applied to historical make/model data to forecast make/model growth rates. Since the growth rate data is initially calculated for 1, 3 and 5 years, interpolation is applied as necessary in finally developing the 6 year, 72 data for each make and model, that is output from FIG. 4, block 42, in FIG. 8 step 805.

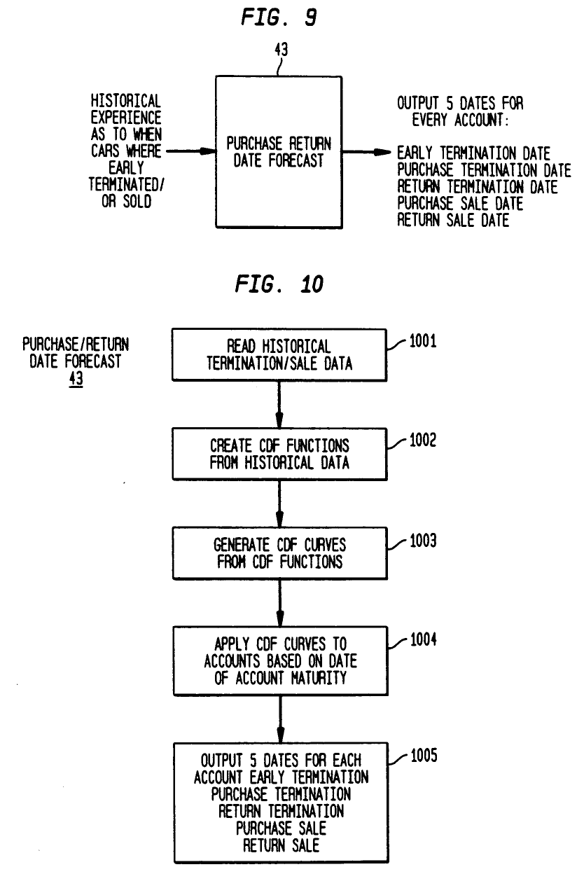

FIG. 9 shows the input and output of FIG. 4, block 43, the purchase/return date forecast block. The input is historical experience as to when cars-were early terminated/or sold. The output is 5 dates for each account, the output 5 dates for every account, the early termination date, the purchase termination date, the return termination date, the purchase sale date, and the return sale date. Note that there is a difference between the termination date and the sale date because there is almost always a gap between the termination date and the actual sale date. In the exemplary embodiment there can be hundreds of thousands of accounts. The number of accounts is only limited by the available computational capacity and time available to run the program steps.

FIG. 10 shows the steps of block 43. The historical termination/sale data is read in, in step 1001. In step 1002, cumulative data functions (CDFs) are created from the historical data. In the exemplary embodiment there are approximately 67 CDFs for the early termination date, 361 CDFs for purchase termination date, 361 return termination date CDFs. Each function represents an option to a particular account. Particular CDF curves can be generated from the CDFs 1003 and then applied to specific accounts. The CDF curves can be selected base on an account criterion such as the date of maturity of a particular account. Selected CDF curves are applied to the accounts based on date of account maturity in block 1004. A Monte-Carlo analysis is performed based on the CDF curves to generate five dates that are output for each account in step 1005. The five dates are the early termination date, the purchase termination date, the return termination date, the purchase sale date, and the return sale date.

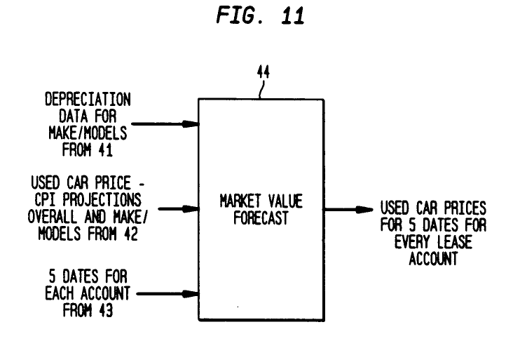

FIG. 11 shows market value forecast FIG. 4, block 44, the market forecast block. The inputs to block 44 are the depreciation data for make/models from block 41, the used car price—CPI projections (overall and make/model) from 42, and 5 dates for each account from block 43. The output is 5 used car prices corresponding to the 5 dates from block 43 for every account.

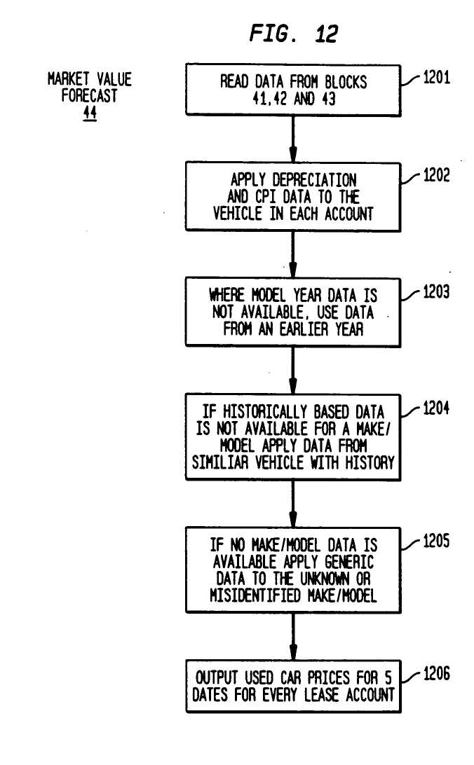

FIG. 12 shows the functions of block 44. Block 44 forecasts the used car prices for every account. After reading the input data 1201, the depreciation data and used car CPI prices are applied to the make/model of that vehicle 1202, or if the data for a specific vehicle make/model is not available, then data from the next most similar make/model is used as represented by block 1203. This block can also fill in depreciation information where a vehicle has not been in existence as long as data is needed for into the future. For example, in year 2003, there is only historically based depreciation data for 3 years maximum for a specific make/model vehicle first introduced in model year 2000. In this case the logic within block 1204 can cause the future projected data for a newer vehicles to also be projected from a like make and or model vehicle. In the worst case a generic projection is made by block 1205, because the data fields must be completed for all leases for all accounts. Block 44 computed data is output in step 1206.

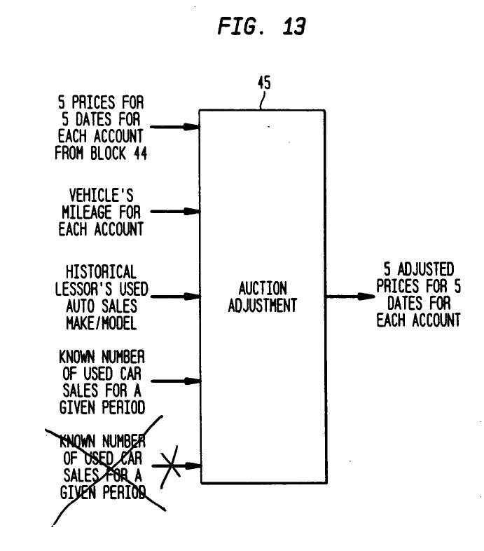

The inputs of FIG. 4, block 45 are shown in FIG. 13. The first input is the 5 used car prices corresponding to the 5 dates from block 44 for every account. Other inputs to block 45 can include the mileage on the vehicle for every account, the lessor's historical experience with previous sales of the make/model, the known, or forecast number of vehicle sales by the lessor for a given period, and the number of total number of used car sales (historical and projected). The output of block 45 is a table of 5 adjusted prices for 5 dates for each account.

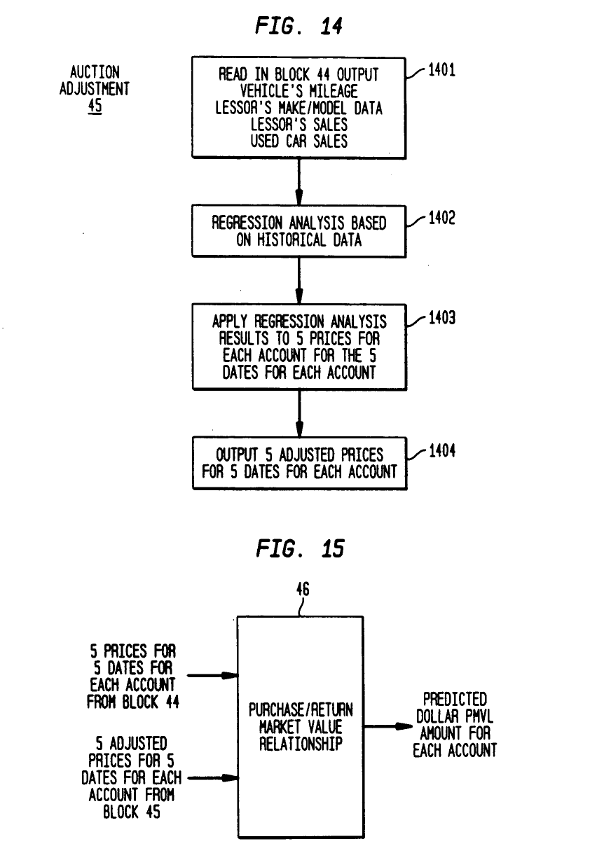

The purpose of block 45 is to adjust the 5 prices from block 44 to reflect the lessor's experience in a particular lease market, here used cars. FIG. 14 shows the steps performed by block 45. First block 45 reads (1401) in 5 used car prices corresponding to the 5 dates from block 44 for every account, the mileage on the vehicle for every account, the lessor's historical experience with previous sales of the make/model, the known, or forecast number of vehicle sales by the lessor for a given period, and the number of total number of used car sales (historical and projected). Historical analysis includes the synthesis of regression parameters based on past sales experience and projected trends (1402). The regression parameters, once applied to the input 5 price numbers for each account, (1403), then result in an output (1404) of 5 adjusted prices for 5 dates for each account. Regression analysis is somewhat effective in modifying the block 44 prices to reflect the lessor's auction experience, but it is does not convey the true spread of prices in the lessor's auction experience. With regression analysis block 44 generated lessor auction average variations of only 1 to 2 percent. Applicant's discovered that a stochastic approach to price adjustment yields more realistic individual account correction factors as high as 60% for specific year/make/model combinations. The preferred embodiment of block 45 assigns correction factors based on CDFs (assuming a normal distribution form) and normal parametric Monte-Carlo analysis.

FIG. 15 shows the inputs and outputs of block 46. The inputs are the 5 prices for the 5 lease activity dates both corrected by auction adjustment block 45 and uncorrected as output by block 44. The output of block 46 is the projected purchase price for every account.

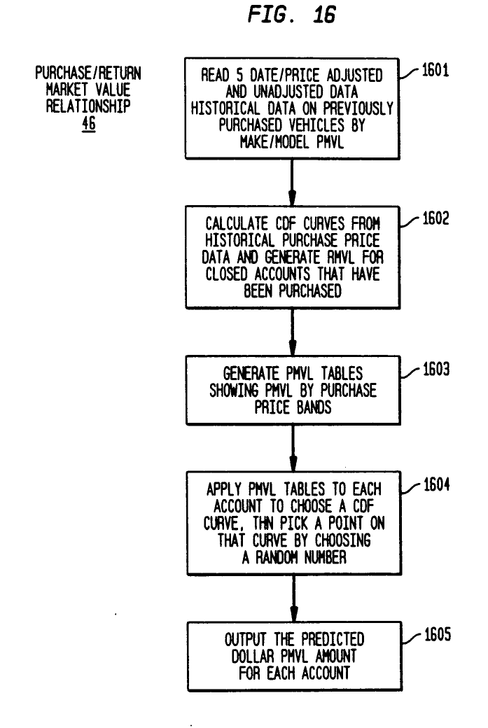

The purpose of block 46 is to determine the projected price of the vehicle if it is purchased at the completion of the lease period by the leasee or the car dealer that leased the vehicle. This scenario is as opposed to the vehicle being sold at auction at sometime following lease termination. Here we are dealing with the purchase market value loss (PMVL). This is the amount of loss caused by a purchase that is below (discounted from) the end of lease contract purchase price. The steps performed by block 46 are show in FIG. 16. First (1601), the information for that account is read, as is historical PMVL by make/model. Next cdf curves are calculated from historical purchase price data and return market values are generated for closed accounts that have been purchased (1602). Also, a pseudo return market value loss (RMVL) number is generated for all of the closed historical accounts. The RMVL reflects the loss that would have occurred in a closed account that ended in purchase, had it ended in auction instead. Closed accounts that fall within $100 increments of RMVL can then be bundled into a table. CDF functions can be generated from this data. In step 1603, tables for forecast PMVL are generated by Monte-Carlo analysis from the CDF curves combined with a random number to reflect variation for a given purchase event. In other words, once a given CDF curve is selected, a point on that particular curve is chosen by based on the selected random number.

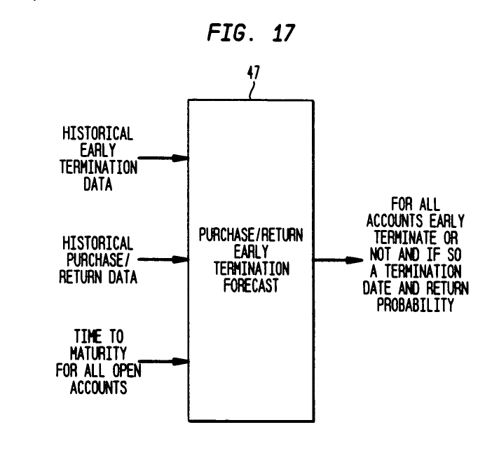

The FIG. 4, block 47 inputs and outputs are show in FIG. 17. Historical data for early termination and for return vs. purchase in now closed accounts is input to this module. Also input is the time to maturity for all open accounts by account identifier. The module assigns three numbers between 0 and 1, as a probabilistic forecast of three mutually exclusive events: early termination, return and purchase.

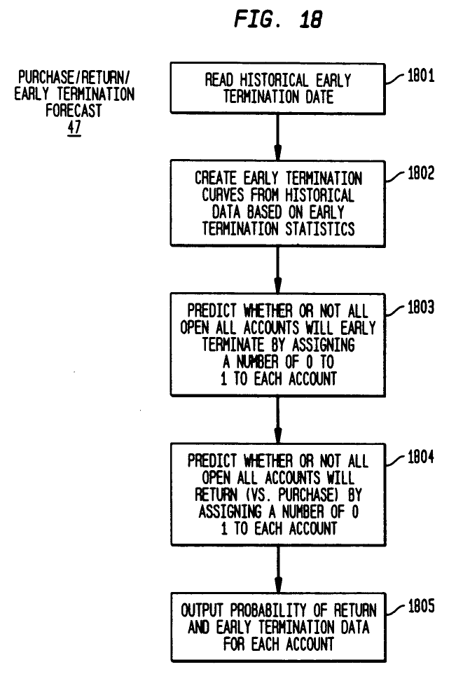

FIG. 4, block 47 estimates whether an open account will early terminate. Historical early termination data is read in (FIG. 18, 1801). Then early termination curves 1803 are generated from the historical data. A probabilistic assignment is made 1803 as to whether each open account will early terminate. An early termination probability number between 0 and 1 is assigned to every account to accomplish the prediction. Also every account is assigned a number between 0 and 1 as to the return probability 1804 of every account (as opposed to purchase). A Monte-Carlo analysis is performed and the results are output in step 1805.

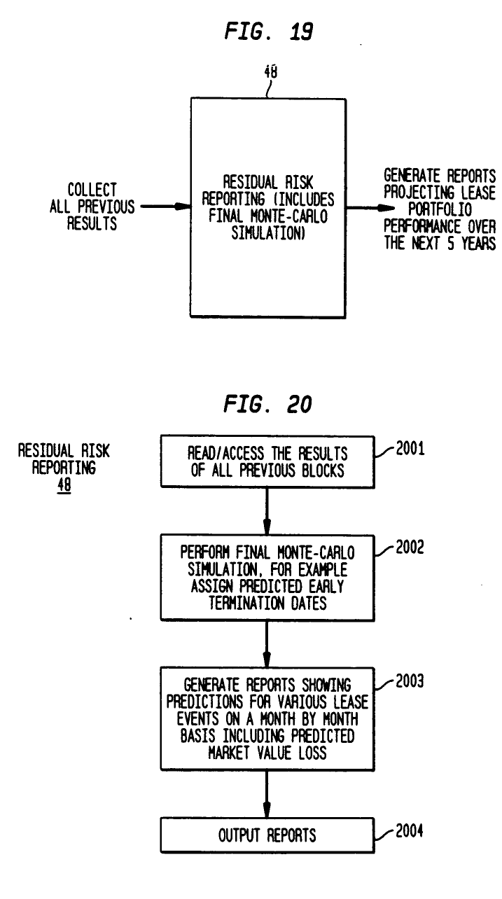

FIG. 4, block 48 receives the computed data from all previous modules (FIG. 20, 2001) as shown in FIG. 19. The output (2004) is a great variety of reports that show in differing formats the projected performance of the lease portfolio. Typically 30 or more reports comprising a total of 100 or more pages of reports are generated (2003) every month. By way of example, one report predicts performance over the next several years on a month by month basis. This projection includes the predicted number of terminations and the predicted value of residual value loss for those accounts. To date, comparisons of predictions with actual performance have achieved predicted results within 2% of actual portfolio performance.

To facilitate understanding, the principal acronyms used throughout are identified in an Appendix hereto.

It can now be seen that a method for evaluating a portfolio of leased depreciable items can comprise the steps of, providing data on leased items, providing data on market forecasts, providing historical data on similar leased items, assigning dates and dollar values of the leased item on those dates subject to occurrences of uncertain timing, estimating residual value of the lease portfolio subject to the assigned dates and dollar values, calculating a reserve level appropriate to the portfolio, and then acting on the evaluation. The method can estimate residual values of the lease portfolio subject to uncertain circumstances by Monte-Carlo analysis. It can also assign dates of occurrences to each lease. The dates of occurrences for each lease, can include one or more event dates such as the early termination date, purchase termination date, return termination date, purchase sale date, and return sale date. Then dollar values representing a forecast value of the leased item can be assigned to the dates of occurrences for each lease. Furthermore, the assigned dollar values can be adjusted to reflect a lessor's own experience at auctions for the sale of previously leased items.

In somewhat more detail, the method for evaluating a portfolio of leased depreciable items can comprise the steps of, providing data on leased items, providing data on market forecasts, providing historical value and lease performance data for similar leased items, calculating depreciation data, calculating the predicted forecast market value for each leased item over the duration of the lease, adjusting the market forecast value to reflect prior lessor auction results, calculating the forecast price of an item as if it is purchased at the end of the lease period, assigning dates of occurrences for each lease, including one or more event dates such as the early termination date, purchase termination date, return termination date, purchase sale date, and return sale date, assigning based on probabilities the outcome of each lease account item as purchased, returned, or lease terminated early, calculating the predicted end of lease market value for each leased item at the completion of each lease, the completion type and date based on probabilities, estimating residual value of the lease portfolio subject to the predicted course for each lease account, reporting the results of the analysis, calculating a reserve level appropriate to the portfolio, and then acting on the evaluation.

The method can include assignment by non-parametric Monte-Carlo analysis, of dates of occurrences for each lease, including one or more event dates such as the termination date, purchase termination date, return termination date, purchase sale date, and return sale date. It can also calculate by non-parametric Monte-Carlo analysis the forecast price of an item as if it is purchased at the end of the lease period. And, probabilities can be assigned to the outcome of each lease account item through non-parametric Monte-Carlo analysis, the outcome of each lease account item as purchased, returned, or lease terminated early. Also, market forecast values can be adjusted through parametric Monte-Carlo analysis, to reflect prior lessor auction results.

### Appendix of Acronyms

CPI—Consumer Price Index

MSRP—Manufacturers Suggested Retail Price

BB—Black Book

CALS—Chase Automotive Lease System

UVC—Universal Vehicle Code

ALS—Automotive Loan System

MMU—Make-Model-Universal Vehicle Code

MM—Make-Model

ALG—Automotive Lease Guide

MVL—Market Value Loss

CDF—Cumulative Distribution Function

PDF—Probability Density Function

PMVL—Purchase Market Value Loss

RMVL—Return Market Value Loss

ET—Early Termination

RT—Return

PU—Purchase

We claim:

1. A method for evaluating a portfolio of leased depreciable items comprising the steps of:
providing data on leased items;
providing data on market forecasts;
providing historical data on similar leased items;
assigning dates and dollar values of the leased item on those dates subject to occurrences of uncertain timing;
estimating residual value of the lease portfolio subject to the assigned dates and dollar values;
calculating a reserve level appropriate to the portfolio; and
acting on the evaluation.

2. The method of claim 1 wherein estimating residual value of the lease portfolio subject to the assigned dates and dollar values comprises estimating residual value of the lease portfolio subject to uncertain circumstances by Monte-Carlo analysis.

3. The method of claim 2 further comprising the step of assigning dates of occurrences to each lease.

4. The method of claim 2 further comprising the step of assigning dates of occurrences for each lease, including one or more event dates selected from the group consisting of early termination date, purchase termination date, return termination date, purchase sale date, and return sale date.

5. The method of claim 4 further comprising the step of assigning dollar values representing a forecast value the leased item to the dates of occurrences for each lease.

6. The method of claim 5 further comprising the step of assigning dollar values to the dates of occurrences for each lease wherein the dollar values are adjusted to reflect a lessor's own experience at auctions for the sale of previously leased items.

7. A method for evaluating a portfolio of leased depreciable items comprising the steps of:
providing data on leased items;
providing data on market forecasts;
providing historical value and lease performance data for similar leased items;
calculating depreciation data;
calculating the predicted forecast market value for each leased item over the duration of the lease;
adjusting the market forecast value to reflect prior lessor auction results;
calculating the forecast price of an item as if it is purchased at the end of the lease period;
assigning dates of occurrences for each lease, including one or more event dates selected from the group consisting of early termination date, purchase termination date, return termination date, purchase sale date, and return sale date;
assigning based on probabilities the outcome of each lease account item as purchased, returned, or lease terminated early;
calculating the predicted end of lease market value for each leased item at the completion of each lease, the completion type and date based on probabilities;
estimating residual value of the lease portfolio subject to the predicted course for each lease account;
reporting the results of the analysis;
calculating a reserve level appropriate to the portfolio; and
acting on the evaluation.

8. The method of claim 7 wherein assigning dates of occurrences for each lease, including one or more event dates selected from the group consisting of early termination date, purchase termination date, return termination date, purchase sale date, and return sale date further comprises assigning by non-parametric Monte-Carlo analysis dates of occurrences for each lease, including one or more event dates selected from the group consisting of early termination date, purchase termination date, return termination date, purchase sale date, and return sale date.

9. The method of claim 7 wherein calculating the forecast price of an item as if it is purchased at the end of the lease period further comprises calculating by non-parametric Monte-Carlo analysis the forecast price of an item as if it is purchased at the end of the lease period.

10. The method of claim 7 wherein assigning based on probabilities the outcome of each lease account item as purchased, returned, or lease terminated early assigning based on probabilities further comprises assigning based on probabilities as calculated through non-parametric Monte-Carlo analysis, the outcome of each lease account item as purchased, returned, or lease terminated early.

11. The method of claim 7 wherein adjusting the market forecast value to reflect prior lessor auction results further comprises adjusting the market forecast value through parametric Monte-Carlo analysis, to reflect prior lessor auction results.
